(19) United States
(12) Patent Application Publication
(10) Pub. No.: US 2015/0026509 A1
(43) Pub. Date: Jan. 22, 2015

(54) STORAGE DEVICE HAVING A DATA STREAM CONVERTER

(71) Applicant: Kabushiki Kaisha Toshiba, Tokyo (JP)

(72) Inventors: Dong ZHANG, Kanagawa (JP); Norikazu YOSHIDA, Kanagawa (JP); Toshikatsu HIDA, Kanagawa (JP)

(73) Assignee: Kabushiki Kaisha Toshiba, Tokyo (JP)

(21) Appl. No.: 13/947,781

(22) Filed: Jul. 22, 2013

(51) Int. Cl. G06F 11/16; G06F 12/02

(52) U.S. Cl. CPC G06F 11/1666; G06F 12/0246
USPC 714/6.11; 711/103

(57) ABSTRACT

According to one embodiment, a storage device has a plurality of memory modules and a memory controller. The memory controller has a first unit configured to receive data to be stored in the memory modules from a host device as a write data stream and transmit data read from the memory modules to the host device as a read data stream, a second unit having a plurality of subunits, each of which is configured to write data in one of the memory modules corresponding to the subunit and read data from one of the memory modules corresponding to the subunit, and a data stream converter configured to parallelize the write data stream into a plurality of data blocks each of which is to be stored in one of the memory modules and to serialize a plurality of data blocks read from the memory modules into the read data stream.

### FIELD

Embodiments described herein relate generally to a storage device having a nonvolatile memory.

### BACKGROUND

The requirements for performance of a storage device using a NAND flash memory (hereinafter, described as a NAND memory) as a nonvolatile memory, for example, a solid state drive (SSD), have become strict.

### BRIEF DESCRIPTION OF THE DRAWING

FIG. 1 is a block diagram showing a structure of a storage device according to a first embodiment.

FIG. 2 is a block diagram showing one example of a main structure of a controller according to the first embodiment.

FIGS. 3 and 4 are block diagrams showing data transfer in a writing mode, within the controller according to the first embodiment.

FIGS. 5 and 6 are block diagrams showing data transfer in a reading mode, within the controller according to the first embodiment.

FIGS. 7 and 8 are block diagrams showing data transfer in a writing mode within a controller according to a second embodiment.

FIG. 9 is a flowchart showing calculation procedure of CRC value in a data stream converter, according to the second embodiment.

FIGS. 10 and 11 are block diagrams showing data transfer in a reading mode within the controller according to the second embodiment.

FIG. 12 is a block diagram for calculating CRC value in the data stream converter, according to a third embodiment.

FIG. 13 is a perspective view showing an example of a personal computer provided with an SSD according to a fourth embodiment.

FIG. 14 is a block diagram showing an example of the personal computer.

FIG. 15 is a conceptual diagram showing an example of a server provided with the SSD according to the fourth embodiment.

### DETAILED DESCRIPTION

Hereinafter, a storage device according to embodiments will be described with reference to the drawings. In the following description, the same reference signs are attached to the components having the same functions and structures, and the overlapped description is made only in the necessary situation.

In general, according to one embodiment, a storage device has a plurality of memory modules and a memory controller. The memory controller has a first unit configured to receive data to be stored in the memory modules from a host device as a write data stream and transmit data read from the memory modules to the host device as a read data stream, a second unit having a plurality of subunits, each of which is configured to write data in one of the memory modules corresponding to the subunit and read data from one of the memory modules corresponding to the subunit, and a data stream converter configured to parallelize the write data stream into a plurality of data blocks each of which is to be stored in one of the memory modules and to serialize a plurality of data blocks read from the memory modules into the read data stream.

### First Embodiment

A storage device includes, for example, an SSD, a Secure Digital (SD) card, a multimedia card, a USB flash memory, and the like.

### [1] Structure of Storage Device

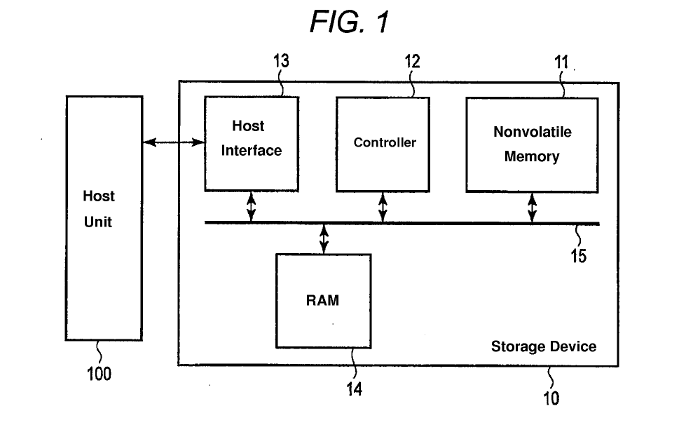

FIG. 1 is a block diagram showing the structure of a storage device according to a first embodiment.

A storage device 10 includes a nonvolatile memory 11, a controller 12, a host interface 13, and a random access memory (RAM) 14. A bus 15 electrically connects the nonvolatile memory 11, the controller 12, the host interface 13, and the RAM 14 with each other.

The nonvolatile memory 11 is accessed by the host unit (hereinafter, referred to as a host) 100 to read and write data and keeps the data even when a power is not supplied. The nonvolatile memory 11 includes a nonvolatile semiconductor memory, for example, a NAND flash memory (hereinafter, referred to as a NAND memory). The NAND memory includes a plurality of blocks for storing data.

Each of the blocks is a physical block including a plurality of memory cells or a logical block including a plurality of physical blocks. Each of the blocks is a unit of erasing, or may be a unit of writing and erasing. Specifically, the physical block is a minimum unit of independently erasing data, within the NAND flash memory. The physical block includes a plurality of physical pages. The logical block is a unit of erasing data that is set within the storage device. One logical block corresponds to one or more physical pages.

The nonvolatile semiconductor memory is not restricted to the NAND flash memory, but it may include other nonvolatile semiconductor memories, for example, a NOR flash memory, a Magnetic Random Access Memory (MRAM), a Resistive Random access memory (ReRAM), and a phase-change random access memory (PRAM).

Further, the nonvolatile semiconductor memory included in the nonvolatile memory 11 may be comprised of, for example, a single package including a single or a plurality of semiconductor chips, or a plurality of packages each including a single or a plurality of semiconductor chips. Alternatively, it may be a flip chip of a single semiconductor chip.

The controller 12 controls the operations on the whole storage device such as the host interface 13, the nonvolatile memory 11, and the RAM 14, according to a signal input from the host 100 through the host interface 13 and using a control program stored in the nonvolatile memory 11 and the RAM 14.

The RAM 14 is used for temporarily storing the transfer data for the host 100 and the nonvolatile memory 11. Further, the RAM 14 is used for storing the management information of the nonvolatile memory 11 and for a data cache. The RAM 14 includes, for example, a DRAM or an SRAM.

The host interface 13 is connected to the host 100 through a communication interface such as PCI Express (PCIe) interface, to transfer signals to and from the host 100. The host 100 is an external device which writes data in and reads data from the storage device 10, comprised of a single unit of, or a combination of, for example, a personal computer, a CPU core, and a server, each of which is connected to a network. Viewed from the host 100, the storage device 10 works, for example, as an external storage device of the host 100.

The data transmitted from the host 100 to the host interface 13 is temporarily stored in the RAM 14, according to a control of the controller 12. Then, it is transferred from the RAM 14 and written in the NAND memory within the nonvolatile memory 11. On the other hand, the data read from the NAND memory within the nonvolatile memory 11 is temporarily stored in the RAM 14. Then, the data is transmitted from the RAM 14 to the host 100 via the host interface 13. The data transmitted from the host 100 to the host interface 13 may be written in the nonvolatile memory 11 without passing through the RAM 14, according to the control by the controller 12. On the other hand, the data read from the NAND memory within the nonvolatile memory 11 may be output to the host 100 without passing through the RAM 14, according to the control by the controller 12.

### [2] Structure of Controller

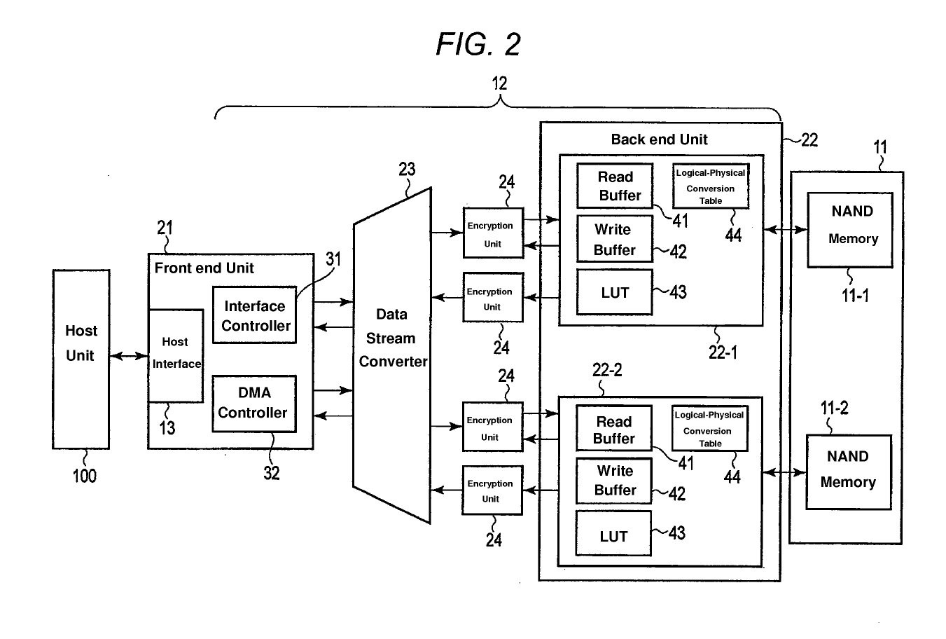

FIG. 2 is a block diagram showing one example of a main structure of the controller 12 shown in FIG. 1.

The controller 12 includes a front end unit 21, a back end unit 22, a data stream converter 23, and encryption units 24. The back end unit 22 includes two subunits: a first back end 22-1 and a second back end 22-2. The nonvolatile memory 11 includes a first NAND memory 11-1 and a second NAND memory 11-2. The back end unit 22 may include three or more back ends, and the nonvolatile memory 11 may include three or more NAND memories.

The front end unit 21 includes an interface controller 31 and a direct memory access (DMA) controller 32. The front end unit 21 may include the host interface 13, which transfers data to and from the host 100. The PCIe is used for the host interface 13, and includes an advanced host controller interface (AHCI) and NVM Express (NVMe) as interfaces. Further, the front end unit 21 includes an error detection and correction functions of the received data. The interface controller 31 controls the operation by the interface. The DMA controller 32 controls a data transfer of the data received by the host interface 13 within the front end unit 21 or controls a data transfer of the data received from the data stream converter 23 within the front end unit 21.

The back end unit 22 executes commands and the like including an access to the nonvolatile memory 11. Each subunit of the back end unit 22 transmits the data to and receives the data from the nonvolatile memory 11 and has an error detection and correction functions of the received data. Each of the back end unit 22 includes a read buffer 41, a write buffer 42, a look-up table (LUT) 43, and a logical-physical conversion table 44. The read buffer 41 temporarily stores the data read from the NAND memory 11-1. The write buffer 42 temporarily stores the write data input from the host 100. The LUT is a table where values for managing correlation between a logical block address (Logical Block Addressing) (hereinafter, referred to as LBA) and a physical block address of the NAND memory 11-1 are recorded. The logical-physical conversion table 44 is a table for converting a logical block address to a physical block address and a physical block address to a logical block address. The logical block address specifies the record position in the logical block. Further, the physical block address specifies the record position in the physical block in the NAND memory 11-1.

The data stream converter 23 is provided between the front end unit 21 and the back end unit 22. The data stream converter 23 parallelizes signals (data, commands, and the like) received from the front end unit 21 into the back ends 22-1 and 22-2, according to a parallelization rule. The data stream converter 23 transfers, for example, first and second clusters included in the data to the back ends 22-1 and 22-2 respectively. Further, the data stream converter 23 serializes the signals (data, response, and the like) received from each subunit of the back end unit 22 according to the parallelization rule and outputs the serialized signals to the front end unit 21. The data stream converter 23 serializes, for example, the data transmitted from the back ends 22-1 and 22-2 and transfers the serialized data to the front end unit 21.

A cluster is a management unit for managing data within the storage device. A cluster size is not less than a sector size and is defined so as to be equal to a data management unit of a file system adopted by the OS of the host, or equal to a logical page size. An integer multiple of two or more of the cluster size may correspond to the logical page size. One cluster corresponds to, for example, eight sectors. The sector is a minimum access unit from the host.

The data stream converter unit 23 converts LBA in a data transfer mode because the LBA is different between the front end unit 21 and the back end unit 22. When the data stream converter 23 parallelizes data into the back ends 22-1 and 22-2, the data does not become serial if the back ends 22-1 and 22-2 use the LBA used in the front end unit 21. Therefore, the LBA is converted according to the parallelization rule.

The encryption unit 24 encrypts a signal transmitted between the data stream converter 23 and the back end unit 22. For example, the encryption unit 24 has an advanced encryption standard (AES) function.

Hereinafter, a flow of writing and reading operations will be simply described.

Writing from the host 100 is as follows. Write data, LBA, and a data attribute are input to the front end unit 21 of the storage device 10 through the host interface 13. The inputted write data, LBA, and data attribute are classified into at least one of the back ends 22-1 and 22-2 by the data stream converter 23. For example, if the write data, LBA, and the data attribute are parallelized into the back end 22-1, they are transferred to the write buffer 42 within the back end 22-1 through the encryption unit 24.

Next, correspondence information between the LBA and the physical block address of the NAND memory 11-1 is set in the LUT 43 and the write data is written in the physical block address of the NAND memory 11-1 from the write buffer 42. Here, for example, a cyclic redundancy check (CRC) value (error detection code) is also created and the write data and the CRC value are written in the NAND memory 11-1.

Reading from the NAND memories 11-1 and 11-2 is performed as follows. A read command input from the host 100 is input to the data stream converter 23 through the front end unit 21 (host interface 13). The read command is classified into the back end 22-1 or 22-2 by the data stream converter 23. For example, if it is parallelized into the back end 22-1, the read command is transmitted to the LUT 43 and the read address specified by the LBA is corresponded to the physical block address of the NAND memory 11-1.

Then, the read command is transferred to the NAND memory 11-1 of the channel corresponding to the physical block address, to read the NAND memory 11-1. The read data is temporarily stored in the read buffer 41 within the back end 22-1, and then transferred to the data stream converter 23 through the encryption unit 24. The read data transferred from the back ends 22-1 and 22-2 is serialized in the data stream converter 23 and transferred to the front end unit 21. Further, the read data is transmitted from the front end unit 21 to the host 100.

### [3] Data Transfer in Controller

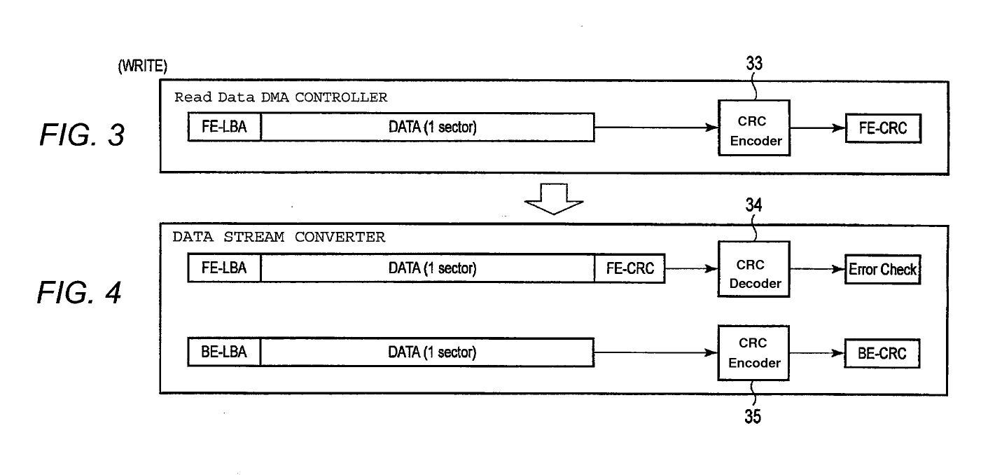

FIGS. 3 and 4 are block diagrams each showing data transfer in the writing mode within the controller 12 according to the first embodiment.

The write data and the LBA are input from the host 100 to the front end unit 21 through the host interface 13. The LBA input in the front end unit 21, namely, the LBA used in the front end unit 21 is hereinafter referred to as FE-LBA. The data length (or bit width) of the LBA is 48 bits and the data length of the write data is 128 bits, for example.

The DMA controller 32 within the front end unit 21 generates a CRC value by encoding the write data and the FE-LBA in the CRC encoder 33. The CRC value generated by the front end unit 21 to be used in the data stream converter 23 is hereinafter referred to as FE-CRC. The bit width processed by the CRC encoder 33 is 256 bits, for example.

Thereafter, the write data, the FE-LBA, and the FE-CRC are transferred to the data stream converter 23. The data stream converter 23 decodes the write data, the FE-LBA, and the FE-CRC in the CRC decoder 34 and checks whether there is an error or not. The bit width processed by the CRC decoder 34 is 256 bits, for example.

Next, the data stream converter 23 converts the FE-LBA into the LBA to be used in the back end unit 22. The LBA to be used in the back end unit is hereinafter referred to as BE-LBA. Then, the data stream converter 23 generates a CRC value by encoding the write data and the BE-LBA in the CRC encoder 35. The CRC value generated in the data stream converter 23 to be used in the back end unit 22 is hereinafter referred to as BE-CRC. The bit width processed by the CRC encoder 35 is 256 bits, for example.

Then, the write data, the BE-LBA, and the BE-CRC are transferred to the back end unit 22. Further, the write data is transferred from the back end unit 22 to the NAND memory 11-1 or 11-2.

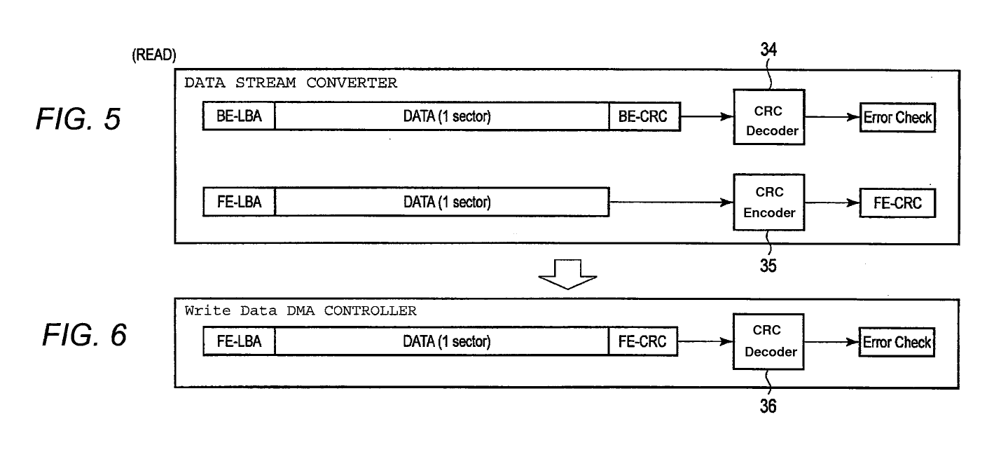

FIGS. 5 and 6 are block diagrams each showing data transfer in the reading mode within the controller according to the first embodiment.

The read data read out from the NAND memory 11-1 is temporarily stored in the read buffer 41 within the back end 22-1 and then transferred to the data stream converter 23 through the encryption unit 24. The data stream converter 23 decodes the read data, the BE-LBA, and the BE-CRC received from the back end 22-1 in the CRC decoder 34 and checks whether there is an error or not.

Next, the data stream converter 23 converts the BE-LBA into the FE-LBA to be used in the front end unit 21. Then, the data stream converter 23 generates a CRC value by encoding the read data and the FE-LBA in the CRC encoder 35. The CRC value created in the data stream converter 23 to be used in the front end unit 21 is hereinafter referred to as FE-CRC.

The read data read out from the NAND memory 11-2 is similarly processed in the back end 22-2 and the data stream converter 23.

The data stream converter 23 merges the read data transferred from the back ends 22-1 and 22-2 and transfers the above merged data to the front end unit 21 together with the FE-LBA and the FE-CRC. Namely, the read data transferred from the back ends 22-1 and 22-2 is converted into serial data (serialized) and the serialized data is transferred to the front end unit 21. The DMA controller 32 within the front end unit 21 decodes the read data, the FE-LBA, and the FE-CRC in the CRC decoder 36 and checks whether there is an error or not. Then, the read data is transmitted from the front end unit 21 to the host 100.

In the first embodiment, since writing and reading can be performed in a multi-channel using the data stream converter and a plurality of back ends, the data can be written and read efficiently at a high speed.

### Second Embodiment

In a second embodiment, an example of acquiring a CRC value with respect to LBA and data, by encoding only the converted LBA in the data stream converter will be described.

As the structure of a storage device and a controller according to the second embodiment is the same as that of the storage device 10 and the controller 12 according to the first embodiment, the description is omitted.

### [1] Data Transfer in Controller

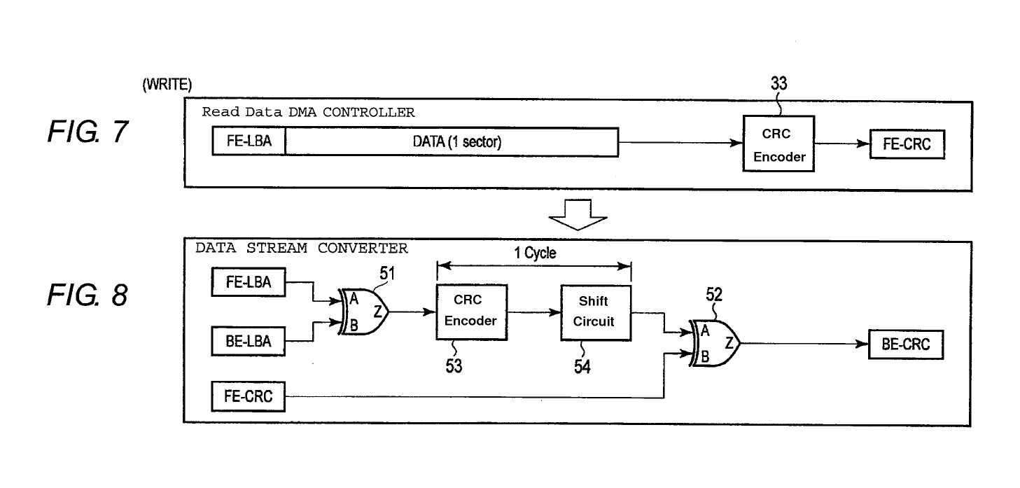

FIGS. 7 and 8 are block diagrams showing data transfer in the writing mode within the controller according to the second embodiment.

The data stream converter 23 includes exclusive OR circuits 51 and 52, a CRC encoder 53, and a shift circuit 54, as illustrated in FIG. 8. The CRC encoder 53 can encode the data corresponding to the data length (or bit width) of LBA. Here, as the data length of the LBA is 48 bits, the CRC encoder 53 has only to be able to encode at least the LBA of 48 bits. The shift circuit 54 is formed as a combination circuit and shifts the data by the data length (or bit width) corresponding to the portion filled with zero (padding data) in the output of the CRC encoder 53. Namely, the shift circuit 54 shifts the output of the CRC encoder 53 by the data length (or bit width) of the write data (or read data). The combination circuit is a circuit whose output is determined only by a combination of input signals, and is formed by a combination of plural logic gates of AND, OR, NOT, and exclusive OR (XOR).

The write data and the FE-LBA are input from the host 100 to the front end unit 21 through the host interface 13. The DMA controller 32 within the front end unit 21 generates a CRC value (FE-CRC) by encoding the write data and the FE-LBA in the CRC encoder 33.

Then, the write data, the FE-LBA, and the FE-CRC are transferred to the data stream converter 23.

Next, the data stream converter 23 converts the FE-LBA into the BE-LBA to be used in the back end unit 22. Then, in the data stream converter 23, the exclusive OR circuit 51 calculates the exclusive OR of the FE-LBA and the BE-LBA. The CRC encoder 53 encodes the output of the exclusive OR circuit 51. The shift circuit 54 shifts the output of the CRC encoder 53 by the data length of the write data and outputs the shifted output to the exclusive OR circuit 52. Further, the exclusive OR circuit 52 calculates the exclusive OR of the outputs of the shift circuit 54 and the FE-CRC, and the calculation result equals to the BE-CRC. Here, for example, the bit width processed by the CRC encoder 53 is 48 bits because the bit width is required only to process the LBA. As the shift circuit 54 is formed of the combination circuit, it can shift the output of the CRC encoder 53 at one cycle of a drive clock.

Then, the data stream converter 23 parallelizes the write data, the BE-LBA, and the BE-CRC to the back end 22-1 or 22-2; namely, transfers these data at least to one of the back ends 22-1 and 22-2. Further, the write data is transferred from the back end 22-1 and 22-2 to the NAND memory 11-1 and 11-2 respectively.

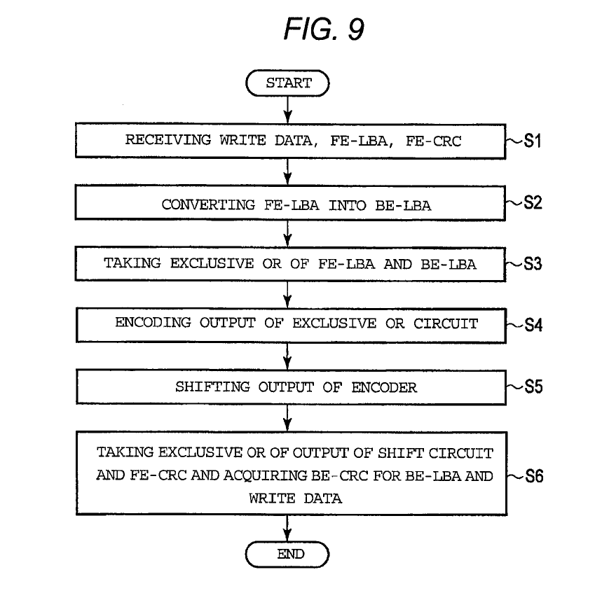

Hereinafter the procedure (algorithm) for calculating a CRC value (BE-LBA) in the data stream converter 23 will be described with reference to FIG. 9.

The data stream converter 23 receives the write data, the FE-LBA, and the FE-CRC (Step S1). The data stream converter 23 converts the FE-LBA into the BE-LBA (Step S2). Then, in the data stream converter 23, the exclusive OR circuit 51 calculates the exclusive OR of the FE-LBA and the BE-LBA (Step S3).

The CRC encoder 53 encodes the output of the exclusive OR circuit 51 (Step S4). The shift circuit 54 shifts the output of the CRC encoder 53 by the data length of the write data (Step S5). Further, the exclusive OR circuit 52 calculates the exclusive OR of the outputs of the shift circuit 54 and the FE-CRC, and the output of the exclusive OR circuit 52 equals to the BE-CRC (Step S6).

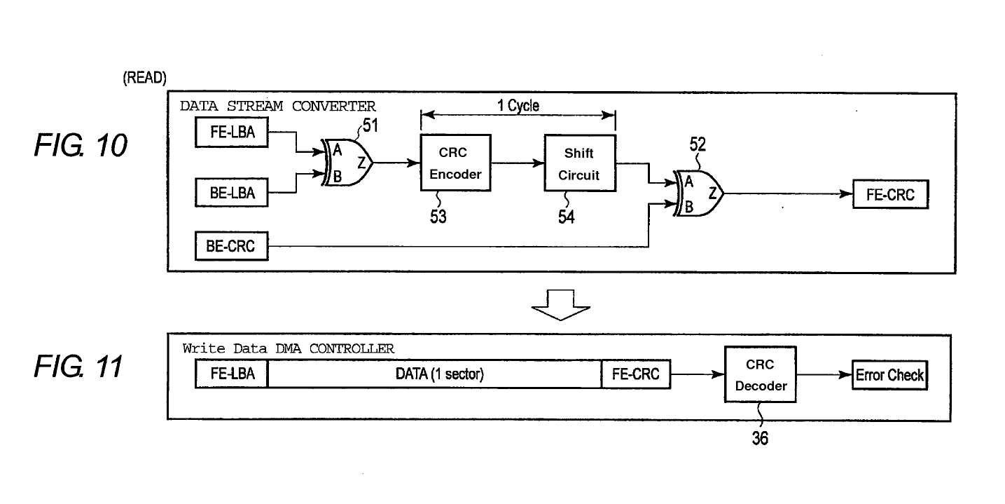

FIGS. 10 and 11 are block diagrams showing data transfer in the reading mode within the controller according to the second embodiment.

The read data read from the NAND memory 11-1 is temporarily stored in the read buffer 41 within the back end 22-1 and then transferred to the data stream converter 23 through the encryption unit 24.

Next, the data stream converter 23 converts the BE-LBA to the FE-LBA to be used in the front end unit 21. Continuously, in the data stream converter 23, the exclusive OR circuit 51 calculates the exclusive OR of the BE-LBA and the FE-LBA. The CRC encoder 53 encodes the output of the exclusive OR circuit 51. The shift circuit 54 shifts the output of the CRC encoder 53 by the data length of the read data and outputs the shifted output to the exclusive OR circuit 52. Further, the exclusive OR circuit 52 calculates the exclusive OR of the output of the shift circuit 54 and the BE-CRC, and the calculation result equals to the FE-CRC. Here, as mentioned above, the bit width processed by the CRC encoder 53 is 48 bits because it has only to be able to process the LBA. As the shift circuit 54 is formed as a combination circuit, the output of the CRC encoder 53 can be shifted at one cycle of a drive clock.

The read data read out from the NAND memory 11-2 is similarly processed in the back end 22-2 and the data stream converter 23.

The data stream converter 23 merges the read data transferred from the back ends 22-1 and 22-2 and transfers the merged data to the front end unit 21 together with the FE-LBA and the FE-CRC. Namely, the read data is arranged in serial (serialized) and transferred to the front end unit 21. In the DMA controller 32 within the front end unit 21, the read data, the FE-LBA, and the FE-CRC are decoded in the CRC decoder 36 and checked whether there is an error. Then, the read data is transmitted from the front end unit 21 to the host 100.

As illustrated in FIGS. 4 and 5, the data stream converter according to the first embodiment includes one decoder and one encoder. Instead, the data stream converter according to the second embodiment is provided with a CRC transshipment circuit including the exclusive OR circuit, the encoder, and the shift circuit, as illustrated in FIGS. 8 and 10. According to this, in the second embodiment, since the decoder can be eliminated, the circuit size, processing time, and power consumption are extremely reduced compared with those in the first embodiment. Further, in the second embodiment, as the write data and the read data are not processed, the continuity of the data can be kept and the data can be protected.

### Third Embodiment

In the second embodiment, the case where the FE-LBA is converted into the BE-LBA or the BE-LBA is converted into the FE-LBA in the data stream converter, namely the case where conversion portion is one, has been described. In a third embodiment, an example of acquiring a CRC value in the case of two and more conversion portions will be described.

### [1] Calculation of CRC Value in Data Stream Converter

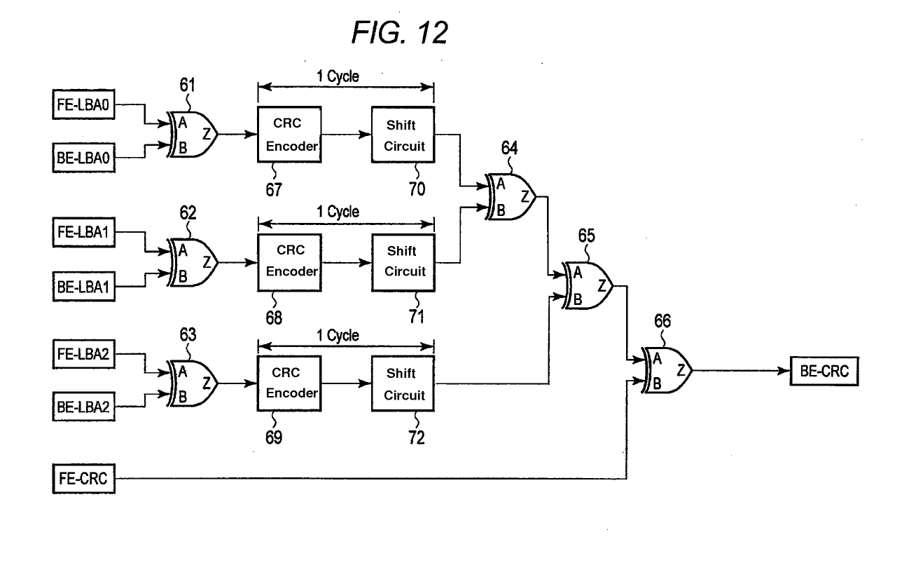

FIG. 12 is a block diagram for calculating a CRC value in the data stream converter, according to the third embodiment.

As illustrated in FIG. 12, the data stream converter includes exclusive OR circuits 61-66, CRC encoders 67-69, and shift circuits 70-72. Each of the CRC encoders can encode data corresponding to the data length (or bit width) of the LBA. Here, as the data length of the LBA is 48 bits, the CRC encoder has only to be able to encode at least the LBA of 48 bits. Each of the shift circuits is formed as a combination circuit, which shifts the output of the CRC encoder by the data length (or bit width) corresponding to the portion filled with zero (padding data). Namely, the shift circuit shifts the output of the CRC encoder by the data length (or bit width) of the write data (or read data).

In the third embodiment, the case where three LBAs: FE-LBA0, FE-LBA1, and FE-LBA2 are respectively converted into BE-LBA0, BE-LBA1, and BE-LBA2 will be described. Here, although the case of converting the LBA is described, the conversion portion may be of the other data than LBA.

For example, the write data, the FE-LBA0, the FE-LBA1, the FE-LBA2, and the FE-CRC are transferred to the data stream converter 23. The FE-CRC is the CRC value created by encoding the write data, the FE-LBA0, the FE-LBA1, and the FE-LBA2.

The data stream converter 23 converts the FE-LBA0, the FE-LBA1, and the FE-LBA2 to the BE-LBA0, the BE-LBA1, and the BE-LBA2 respectively.

Next, in the data stream converter 23, the exclusive OR circuit 61 calculates the exclusive OR of the FE-LBA0 and the BE-LBA0. The CRC encoder 67 encodes the output of the exclusive OR circuit 61. The shift circuit 70 shifts the output of the CRC encoder 67 by the data length of the write data and outputs the shifted output to the exclusive OR circuit 64.

Further, the exclusive OR circuit 62 calculates the exclusive OR of the FE-LBA1 and the BE-LBA1. The CRC encoder 68 encodes the output of the exclusive OR circuit 62. The shift circuit 71 shifts the output of the CRC encoder 68 by the data length of the write data and outputs the shifted output to the exclusive OR circuit 64.

Further, the exclusive OR circuit 63 calculates the exclusive OR of the FE-LBA2 and the BE-LBA2. The CRC encoder 69 encodes the output of the exclusive OR circuit 63. The shift circuit 72 shifts the output of the CRC encoder 69 by the data length of the write data and outputs the shifted output to the exclusive OR circuit 65.

Further, the exclusive OR circuit 64 calculates the exclusive OR of the output of the shift circuit 70 and the output of the shift circuit 71 and outputs the calculation result to the exclusive OR circuit 65. Further, the exclusive OR circuit 65 calculates the exclusive OR of the output of the exclusive OR circuit 64 and the output of the shift circuit 72 and outputs the calculation result to the exclusive OR circuit 66. Further, the exclusive OR circuit 66 calculates the exclusive OR of the output of the exclusive OR circuit 65 and the FE-CRC and the calculation result becomes the BE-CRC.

As mentioned above, when the conversion portion is two and more (three in this case), each of the conversion portions is subjected to the exclusive OR calculation, encoding, and shift operation, and by taking the exclusive OR of the above output data and the data before change (FE-CRC), a CRC value of the converted data can be calculated. The other components and effects in the third embodiment are the same as those in the first and second embodiments.

### Fourth Embodiment

In a fourth embodiment, an example of using an SSD as the above-mentioned storage device will be described.

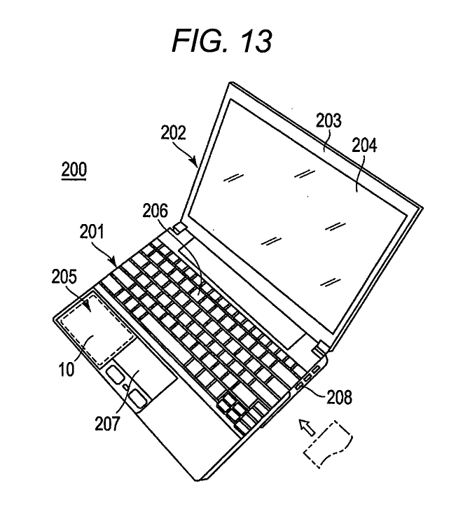

FIG. 13 is a perspective view showing an example of a personal computer installed with the SSD according to the fourth embodiment.

A personal computer 200 includes a main body 201 and a display unit 202. The display unit 202 includes a display housing 203 and a display 204 provided in the display housing 203.

The main body 201 includes a box case 205, a keyboard 206, and a touch pad 207 that is a pointing device. The box case 205 accommodates a main circuit substrate, an Optical Disk Device (ODD) unit, a card slot, and SSD 10.

A card slot is provided on the peripheral wall of the box case 205. The peripheral wall is provided with an opening portion 208 opposite to the card slot. A user can insert and pull out an additional device in and from the card slot externally from the box case 205 through the opening portion 208.

The SSD 10 may be used, as a replacement of a conventional hard disk drive (HDD), in a state in which the SSD 10 is provided inside the personal computer 200 or may be used as an additional device in a state in which the SSD 10 is inserted into the card slot provided in the personal computer 200.

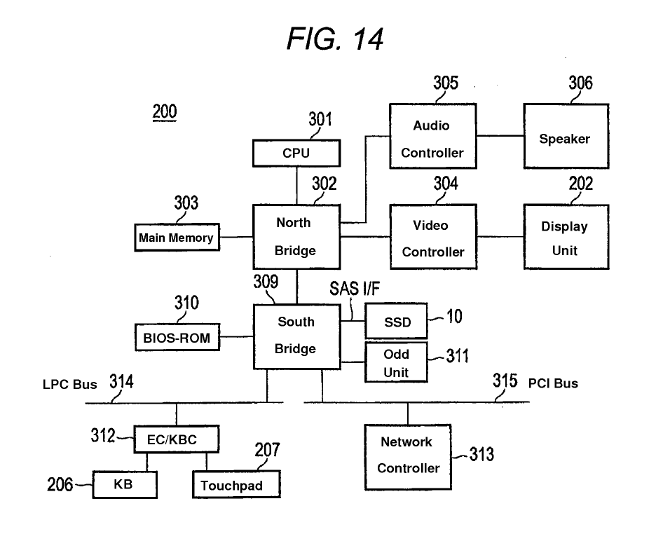

FIG. 14 is a block diagram showing a constitution example of the personal computer.

The personal computer 200 includes a CPU 301, a north bridge 302, a main memory 303, a video controller 304, an audio controller 305, a south bridge 309, a BIOS-ROM 310, the SSD 10, an ODD unit 311, an embedded controller/keyboard controller IC (EC/KBC) 312, a network controller 313, and the like.

The CPU 301 is a processor provided in order to control the operation of the personal computer 200, and performs the operating system (OS) loaded from the SSD 10 to the main memory 303. Further, when the ODD unit 311 enables at least one of reading and writing operations for an optical disk loaded, the CPU 301 performs the operation.

The CPU 301 also performs the Basic Input Output System (BIOS) stored in the BIOS-ROM 310. Here, the BIOS is a program for controlling the hardware within the personal computer 200.

The north bridge 302 is a bridge device for connecting a local bus of the CPU 301 to the south bridge 309. The north bridge 302 also contains a memory controller for controlling access to the main memory 303.

The north bridge 302 has a function of communicating with the video controller 304 and the audio controller 305 through an Accelerated Graphics Port (AGP) bus 314.

The main memory 303 temporarily stores a program and data and functions as a work area of the CPU 301. The main memory 303 is formed by, for example, a RAM.

The video controller 304 is a video reproduction controller for controlling the display unit 202 used as the display monitor of the personal computer 200.

The audio controller 305 is an audio reproduction controller for controlling a speaker 306 of the personal computer 200.

The south bridge 309 controls the respective devices on a Low Pin Count (LPC) bus and on a Peripheral Component Interconnect (PCI) bus 315. The south bridge 309 controls the SSD 10 that is the storage for storing various kinds of software and data, through an SAS interface (SAS I/F).

The personal computer 200 gains access to the SSD 10 by the unit of sector. Write command, read command, cache flash command, and the like are inputted to the SSD 10 through the SAS interface.

Further, the south bridge 309 has a function for controlling access to the BIOS-ROM 310 and the ODD unit 311.

The EC/KBC 312 is one chip micro-computer where the embedded controller for power management and the keyboard controller for controlling the keyboard (KB) 206 and the touch pad 207 are integrated.

The EC/KBC 312 has a function of turning ON and OFF the personal computer 200 according to a user's operation of the power button. The network controller 313 is a communication unit for communicating with the external network, for example, the Internet.

Next, a server provided with the SSD according to the fourth embodiment will be described.

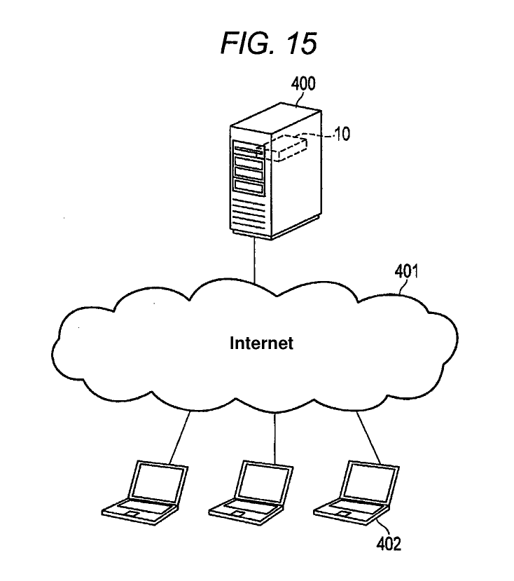

FIG. 15 is a conceptual diagram showing an example of using a server with the SSD according to the fourth embodiment.

A server 400 is connected to an Internet 401. The SSD 10 is provided in the server 400. Further, a plurality of terminals, for example, computers 402 are connected to the Internet 401. A user gains access to the SSD 10 within the server 400 from the computer 402 through the Internet 401. The structure and operation of the SSD 10 is the same as that of the above mentioned embodiment.

Here, the embodiment is not applied restrictively to the SSD only. It may be applied to the other storage device such as SD (Secure Digital) card, multimedia card, and USB flash memory, and the electronic equipment including the storage device such as a personal computer and a server, and the other electronic equipment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A storage device comprising:
a plurality of memory modules; and
a memory controller having:
a first unit configured to receive data to be stored in the memory modules from a host device as a write data stream and transmit data read from the memory modules to the host device as a read data stream,
a second unit having a plurality of subunits, each of which is configured to write data in one of the memory modules corresponding to the subunit and read data from one of the memory modules corresponding to the subunit, and
a data stream converter configured to parallelize the write data stream into a plurality of data blocks each of which is to be stored in one of the memory modules and to serialize a plurality of data blocks read from the memory modules into the read data stream.

2. The storage device according to claim 1, wherein the data stream converter is configured to determine whether the write data stream includes an error and correct the error.

3. The storage device according to claim 2, wherein the first unit includes a direct memory access controller configured to generate an error detection code based on which the data stream converter determines whether the write data stream includes the error.

4. The storage device according to claim 1, wherein the data stream converter is configured to determine whether each of the data blocks read from one or more subunits of the second unit includes an error and correct the error, wherein
the corrected read data blocks are serialized by the data stream converter.

5. The storage device according to claim 1, wherein
the first unit is configured to determine whether the serialized read data stream includes an error and correct the error.

6. The storage device according to claim 1, wherein
the first unit recognizes locations in the memory modules at which data is or is to be stored by addresses of a first address space, and each of the subunits of the second unit recognizes the locations of the data by addresses of a second address space that is smaller than the first address space.

7. The storage device according to claim 6, wherein
the write data stream that the data stream converter parallelizes is accompanied by an address within the first address space, and
the data stream converter is configured to convert the address and transmit each of the data blocks together with a converted address to the second unit.

8. The storage device according to claim 6, wherein
each of the data blocks read from each of the subunits of the second unit is accompanied by an address with the second address space, and
the data stream converter is configured to convert each of the addresses and transmit the read data stream together with a converted addresses to the first unit.

9. A method for writing data in a plurality of memory modules of a storage device including at least a first memory module and a second memory module, the method comprising:
receiving data to be stored in the memory modules of the storage device from a host device as a write data stream;
parallelizing the write data stream into a plurality of data blocks including first and second data blocks, each of which is to be stored in one of the memory modules of the storage device; and
transmitting the first data block to the first memory module to be written therein and transmitting the second data block to the second memory module to be written therein.

10. The method according to claim 9, wherein
the first and second data blocks are simultaneously transmitted to the respective first and second memory modules.

11. The method according to claim 9, further comprises:
determining whether the read data stream includes an error; and
correcting the error before the data is parallelized.

12. The method according to claim 9, wherein
a location in the memory modules at which the received data is to be stored is recognized by addresses of a first address space, and a location in the memory modules at which each of the parallelized data is to be written is recognized by addresses of a second address space that is smaller than the first address space.

13. The method according to claim 12, wherein the received data is accompanied by an address within the first address space, and the method further comprising:
converting the address.

14. A method for reading data stored in a plurality of memory modules of a storage device including at least a first memory module and a second memory module, the method comprising:
reading, in parallel, a plurality of data blocks from the memory modules of the storage device, the data blocks including first and second data blocks read from the respective first and second memory modules;
serializing the data blocks into a read data stream; and
transmitting the read data stream to a host device.

15. The method according to claim 14, wherein
the first and second data blocks are simultaneously read from the respective first and second memory modules.

16. The method according to claim 14, further comprising:
determining whether each of the data blocks read from the memory modules of the storage device includes an error; and
correcting the error before the data block is serialized.

17. The method according to claim 14, further comprising:
determining whether the serialized read data stream includes an error; and
correcting the error.

18. The method according to claim 14, wherein
a location in the memory modules from which the data block is read is recognized by addresses of a first address space, and a location in the memory modules from which the data block is read is recognized by addresses of a second address space that is smaller than the first address space in each of the units.

19. The method according to claim 18, wherein
the data blocks read from each of the memory modules is accompanied by an address within the second address space, and the method further comprising:
converting the address.
